(19) United States
(12) Patent Application Publication
(10) Pub. No.: US 2002/0116833 A1
(43) Pub. Date: Aug. 29, 2002

(54) Length extenders for standard levels

(76) Inventor: Gerald R. Hollenbeck, Lakewood, CO (US)

Correspondence Address: Gerald R. Hollenbeck, 130 S. Ames St., Lakewood, CO, 80226, US

(21) Appl. No.: 09/793,814

(22) Filed: Feb. 26, 2001

(51) Int. Cl. G01C 9/00

(52) U.S. Cl. 33/374; 33/375

(57) ABSTRACT

A means of extending the useful length of standard spirit levels currently in production and in use throughout the world. The length extension hardware is comprised of pairs of extender sleeves which fit over the core level to be extended and provided with means to secure the configuration at any selected length between the minimum and maximum lengths attainable with the core level and extender sleeve set being employed.

Efforts to develop a practical means of providing the benefits of extensible levels have a long history with patents extending back to 1901. Of the dozens of such patents issued in this century, all have been predicated on a specially designed core level adapted to mate with special matching extension elements and with provisions for locking the elements together at the desired configuration length. Some of the designs reviewed offer extension only in fixed increments (U.S. Pat. Nos. 2,879,606 to Olivere and 5,433,011 to Scarborough, et.al.). Others permit continuously variable configuration length between the minimum and maximum values attainable with the hardware being employed (U.S. Pat. Nos. 3,104,477 to Edwill, 3,648,378 to Thingstad et.al., 4,607,437 to McSorley, 4,928,395 to Good and 5,412,875 to Hilderbrandt). In some cases, the design was intended to provide a straightedge provision over the entire length. In most cases, this further complication was avoided.

Many of the designs reviewed involve sliding members with extremely close tolerances as a means of maintaining level measurement accuracy with a straight, flat-bottomed configuration at all extension lengths. This approach is susceptable to jamming from workplace debris such as sawdust which may necessitate frequent cleaning.

### OBJECTS AND ADVANTAGES

The primary objectives of my invention are to provide an economical, easy to use and versatile means of extending the useful length of standard spirit levels currently in production and in use throughout the world.

### BRIEF DESCRIPTION OF THE DRAWINGS

Two sheets of drawing figures are included with this patent application. The first sheet displays the elements of the level extension concept. Also shown is an example of a single extension sleeve positioned over one end of a standard level. The second sheet presents views of standard levels equipped with a pair of extension sleeves in a variety of extended conditions.

### REFERENCE NUMERALS

10 core level

12 extender sleeve

14 extender sleeve cutout

16 sleeve-lock thumbscrew

18 core level body

20 end contour of cast-type level

22 threaded steel insert

24 non-marring thumbscrew tip

26 core level bubble vial

### SUMMARY

A method of extending the useful length of standard spirit levels has been developed. Such levels can be combined with a pair of extender sleeves which fit over the level to be extended and which can be telescoped to any length desired within the the maximum limit of preserving enough overlap of the sleeves on the level to permit securing the elements together with appropriate thumbscrews or equivilant threaded into the top walls of the sleeves.

Preferred Embodiment—Description

List of Figures

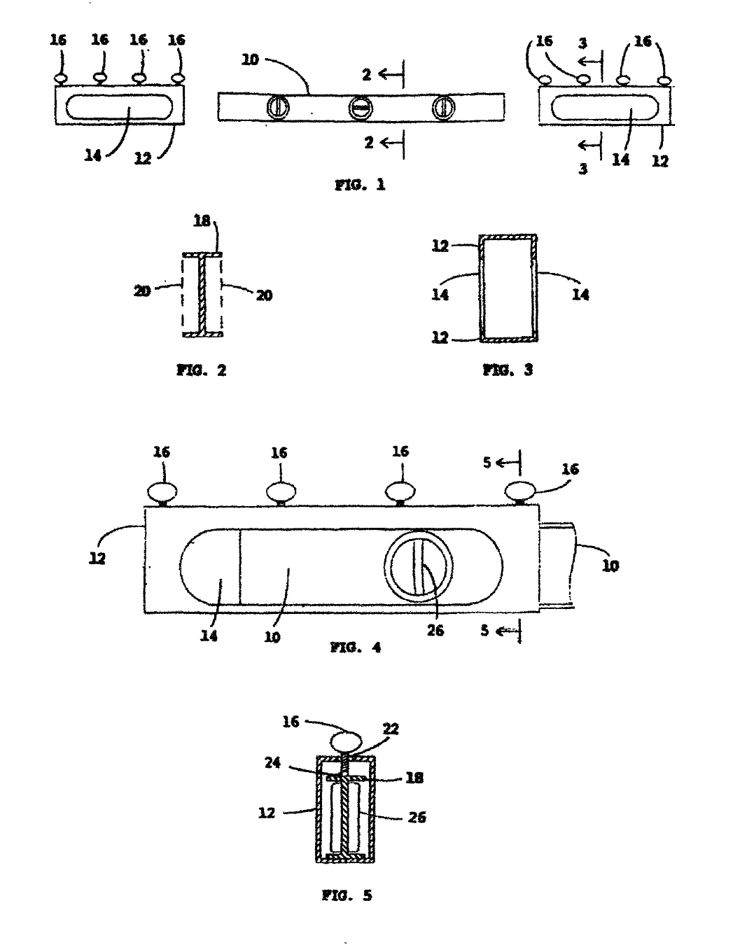

FIG. 1 shows the elements of an extendable level.

FIG. 2 shows the cross-section of a typical standard level.

FIG. 3 shows the cross-section of a typical extender sleeve.

FIG. 4 shows an extender sleeve positioned on a core level.

FIG. 5 shows a cross-section of FIG. 4.

FIG. 6 shows an extendable level set at minimum length.

FIG. 7 shows an extendable level set at intermediate length.

FIG. 8 shows an extendable level set at maximum length.

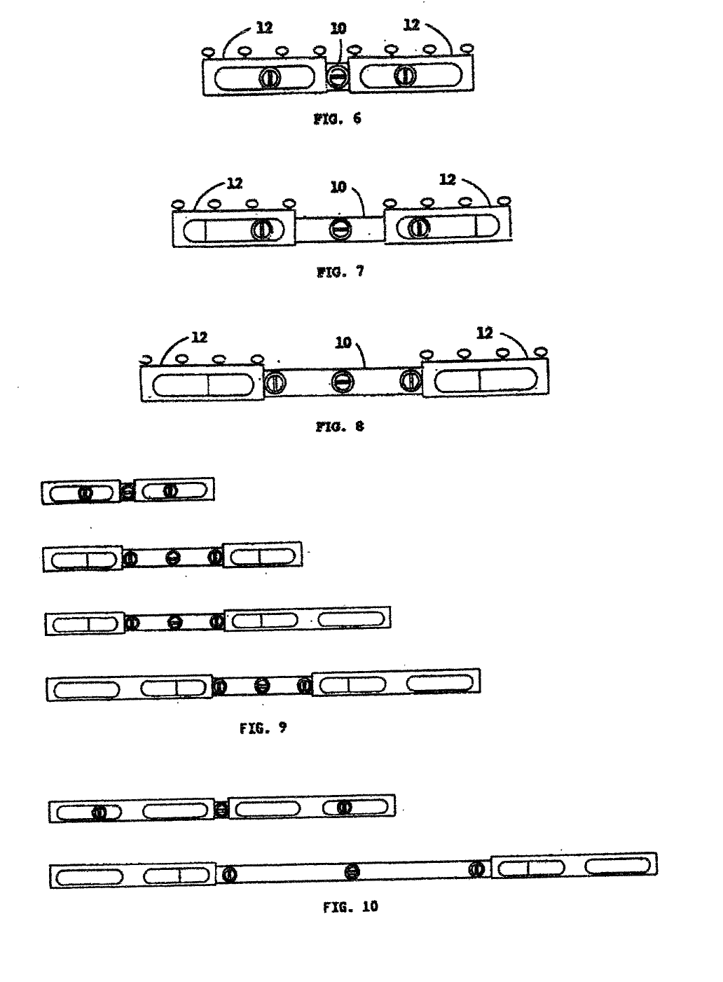

FIG. 9 shows a composite of configuration lengths attainable with a two foot long core level and various combinations of 11 inch long extender sleeves and 23 inch long extender sleeves.

FIG. 10 shows a composite of configuration lengths attainable with a four foot long core level and 23 inch long extender sleeves.

FIG. 1 depicts the elements from which a level of variable length can be assembled. The central element is a standard production level 10 with no modifications. A pair of identical extender sleeves 12 is shown detached from the core level. These sleeves, which fit over the core level, are fabricated from aluminum, plastic or other suitable material by extrusion, injection molding or casting processes. The wall thickness of the hollow extender sleeves will be in the range of 1/16th to ⅛th inch.

Cutouts 14 in the extender sleeve side walls are provided to permit viewing of the core level bubble vials 26 when the elements are assembled. Multiple thumbscrew bolts 16 are mounted in the top of each extender sleeve which serve the purpose of securing the sleeves to the core level at the desired extended length position.

FIGS. 2 through 5 are shown at an enlarged scale to better illustrate some of the relevant details. Most production spirit levels are formed from aluminum with an I-beam cross-section 18 such as displayed in FIG. 2. Many designs are produced by extrusion which results in open ends for the core level. Other models are produced by casting which permits closed box ends 20 for the level. It is the object of the subject invention to accomodate both types of level.

The interior dimensions of extender sleeves are sized to allow telescoping over the bodies of all production levels which differ somewhat in height and width among different manufacturers. Sufficient clearance is provided to avoid the problem of members jamming from contamination with workplace debris.

Preferred Embodiment—Description (cont.)

Following initial fabrication of the extender sleeves, some finish machining will probably be required to flatten and straighten the bottom surfaces for level measurement accuracy. Also, the inside surfaces of the bottom sleeve flanges must be parallel to the bottom surfaces and similarly flat and straight with the inside corners square to avoid conflict with core level edges.

The extender sleeve cross-section of FIG. 3 shows the location of the vial view cutouts which are somewhat below center due to the space involved with the thumbscrew function as illustrated in FIG. 5.

FIG. 4 shows an extender sleeve positioned on a core level at a partially extended length condition. As indicated, one of the thumbscrew bolts is out of position to contribute to locking the two elements together.

The cross-section of FIG. 5 shows the two elements of the thumbscrew in a lowered condition for locking purposes. For tool durabilty, the steel thumbscrew bolts are mated to threaded female steel inserts 22 installed in the upper flanges of the extender sleeves. Another consideration involves avoiding unintentional damage to the core level surfaces from interaction with the thumbscrew tips. Such a result could degrade the measurement accuracy of the core level in subsequent use. Both top and bottom of the core level are of concern since repeated use of the extender sleeves will no doubt involve both of the critical surfaces.

A durable non-marring material 24 such as nylon or teflon will be securely attached to the tip of each thumbscrew bolt. By this means, damage to the core level can be prevented even if the thumbscrews are made tighter than necessary for secure locking of the elements.

Preferred Embodiment—Operation

FIGS. 6, 7 and 8 illustrate the variety of extendable level configurations attainable by a user. These figures, as well as FIG. 1, are predicated on the proportions of a two foot long core level and extender sleeves of 11 inches length each. FIGS. 2 through 5 are generic and apply equally to core levels of different length and to extender sleeves of different length. To maintain core level accuracy, an extender of some length is required at each end of the core level.

The configuration shown in FIG. 6 relates to minimal extension (down to essentially zero) and/or a practice of storing the length extenders on the core level between uses of the extension capabilities. In this condition, all three of the spirit bubble vials usually provided by the core level manufacturer are visable and usable due to the extender length of 11 inches displayed for the example.

FIG. 7 depicts the three elements in an intermediate length configuration (eg. 30 inches). This arrangement, as well as all lengths between 24 and 30 inches, retains visibility of all three bubble vials without special attention to whether the extender sleeves at opposite ends are displaced from center by equal amounts.

The maximum length for this set of elements is 36 inches as shown in FIG. 8. All three bubble vials are visible when the extender sleeves are fully extended. However, some intermediate lengths between 30 and 36 inches could result in obscuring one of the outside vials if extender sleeves are offset by equal amounts. This situation is usually readily resolved by unequal offsets of the two sleeves. In some circumstances, obscuration of one of the outside vials may be unavoidable. In this case, it will be necessary to choose which of the outside vials to leave in view if the two outside vials provide different features such as spirit tubes oriented vertically or at 45 degrees to the core level long axis.

The foregoing mention of maximum configuration length (36 inches) is based on the requirement to have at least 2 thumbscrews in position to force the extender sleeve to a parallel alignment with the core level. Shorter configuration lengths which would allow use of more than two thumbscrews can be securely locked by use of only the two appropriate thumbscrews which are furthest apart. FIG. 7 illustrates a case involving this option.

It is anticipated that extender sleeves will be marketed in a package including a pair of 11 inch long sleeves as previously discussed and a pair of 23 inch long sleeves with an appropriate number of thumbscrews. FIGS. 9 and 10 illustrate the range of configuration length options available with such a set of extender sleeves and two core levels of popular length. The left side positions of the level assemblies of these figures are vertically aligned to facilitate visual interpretation. (Thumbscrews have been omitted from these figures.)

Preferred Embodiment—Operation (cont.)

FIG. 9 demonstrates that a two foot level can be extended to useful lengths as long as 3 feet if only a pair of 11 inch extenders are employed. If 23 inch extenders are used at one or both ends of a two foot core level, configuration lengths as long as 5 feet can be attained. A four foot core level can further extend the range of continuously variable lengths up to 7 feet as illustrated in FIG. 10.

Even longer levels (such as 6 feet) are commercially available and could be employed for special requirements. However, most level users do not possess or need such tools. An economical alternative in case of need could be formed from two appropriate core levels joined together with a single extender sleeve and additional sleeves at each end of the assembly.

Longer extender sleeves with appropriate numbers of sleeve cutouts and thumbscrews could be provided. This is not deemed necessary for most customer use and at some point would become impractical to produce and measurement accuracy could not be maintained.

Conclusions, Ramifications, and Scope

Extendable levels based on the means described can be usefully employed by large numbers of amateur and professional craftsmen in this country and abroad. Such an improved too can be expected to reduce the incidence of construction errors as well as to relieve the frustration frequently experienced with existing levels. Some of the design details presented in this specification are subject to optional variations without departing from the basic concept. A prime example could be replacing the thumbscrew bolts used for illustration with knurled-knob bolts which may be easier for some persons to operate. Other minor modifications could also be considered if production or marketing advantages are identified.

In contrast to some of the prior art patents, the subject invention is not intended for use as a straight-edge or ruler. However, a properly adjusted level configuration could be used to transfer dimensions such as door widths and heights to another location. Another example of such an application would be positioning of suspended ceiling rails to a uniform height above the floor. These uses are more readily accomplished with extendable levels than with standard production levels which are usually either too short or too long to match specific requirements.

What is claimed is:

1. A means of extending the useful length of most standard spirit levels, hereafter referred to as core levels, currently in production and in use by application of pairs of extender sleeves which fit over the core level to be extended and which can be telescoped to any length between that of the core level and the maximum extension of the sleeves preserving enough overlap to assure flat and planar alignment of the bottom surface of the assembly and secured in the selected length position by tightening of appropriate thumbscrews or equivilant threaded into the top walls of sleeves and interfacing with the top surface of the core level.

2. The core level extension means of claim 1 with pairs of extender sleeves equipped with multiple thumbscrews or equivilant on the top of the extender sleeves with the thumbscrews engaging the extender sleeves by means of threaded steel inserts installed in the top walls of the sleeves and with non-marring material applied to the interfacing ends of the thumbscrews.

3. The core level extension means of claim 1 comprised of pairs of extender sleeves which fit over the core level being employed and with cutouts in both sides of the extender sleeves to permit view of most bubble vials in all assembly lengths between the minimum and maximum lengths attainable with any size core level and any combination of extender sleeves being employed.
